(19) United States
(12) Patent Application Publication
(10) Pub. No.: US 2025/0147527 A1
(43) Pub. Date: May 8, 2025

(54) CONTROL APPARATUS, CONTROL METHOD AND PROGRAM THEREOF

(71) Applicant: DENSO CORPORATION, Kariya-city (JP)

(72) Inventors: Naoya SAKAGUCHI, Kariya-city (JP); Eiji KITAMURA, Kariya-city (JP)

(73) Assignee: DENSO CORPORATION, Kariya-city (JP)

(21) Appl. No.: 19/016,374

(22) Filed: Jan. 10, 2025

Related U.S. Application Data
(63) Continuation of application No. PCT/JP2023/027462, filed on Jul. 26, 2023.

(30) Foreign Application Priority Data
Oct. 6, 2022 (JP) 2022-161886

(51) Int. Cl. G05D 7/06

(52) U.S. Cl. CPC G05D 7/0676

(57) ABSTRACT

A control apparatus controls a fan motor that causes a fan to rotate for blowing air to an object to be cooled. The control apparatus is provided with a processor and memory. The processor determines whether the fan motor is submerged and causes the fan motor to operate after eliminating a submergence of the fan motor in response to determination that the fan motor is submerged.

This application is the U.S. bypass application of International Application No. PCT/JP2023/027462 filed on Jul. 26, 2023 which designated the U.S. and claims priority to Japanese Patent Application No. 2022-161886 filed on Oct. 6, 2022, the contents of both of these are incorporated herein by reference.

### BACKGROUND

### Technical Field

The present disclosure relates to a control apparatus, a control method and a control program thereof for controlling a fan motor causing a fan to rotate for blowing air to an object to be cooled.

### Description of the Related Art

As a conventional technique, a fan motor used for causing a fan to rotate for blowing air to an object to be cooled is known. Some of these types of motors may be arranged at a portion which may be submerged in water.

As a result of detailed research by inventors, the inventors discovered a problem that residual water drops may be present in the fan motor arranged at a portion which may be submerged in water, even after eliminating the submergence.

### SUMMARY

The present disclosure has been achieved in light of the above-described circumstances and provides a control apparatus, a control method and program thereof capable of preventing water drops from remaining inside a fan motor after eliminating the submergence.

As a first aspect, the present disclosure provides a control apparatus that controls a fan motor casing a fan to rotate for blowing air to an object to be cooled, including a processor and a memory unit. The processor is configured to determine whether the fan motor is submerged and to cause the fan motor to operate after eliminating a submergence of the fan motor in response to determination that the fan motor is submerged.

### BRIEF DESCRIPTION OF THE DRAWINGS

FIG. 1 is a schematically diagram showing an example of a colling system;

FIG. 2 is a diagram showing a vertical cross-section of an example of a fan motor,

FIG. 3 is a block diagram showing an example of a control circuit;

FIG. 4 is an explanatory diagram showing a state where water drops adhered to a rotor are scattered due to a centrifugal force of the rotor, and

FIG. 5 is a flowchart showing an example of a motor control process.

### DETAILED DESCRIPTION OF THE PREFERRED EMBODIMENTS

As a conventional technique, for example, patent literature JP-A-2019-73200 discloses a fan motor used for causing a fan to rotate for blowing air to an object to be cooled. Some of these types of motors may be arranged at a portion which may be submerged in water. As a result of detailed research by inventors, the inventors discovered a problem that residual water drops may be present in the fan motor arranged at a portion which may be submerged in water, even after recovering the submergence.

Firstly, a cooling system according to one embodiment of the present disclosure will be described.

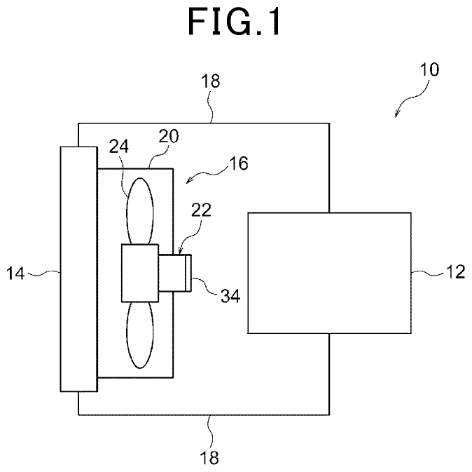

As one example shown in FIG. 1, the cooling system 10 according to an embodiment of the present disclosure serves as a system for cooling an engine 12 of a vehicle such as a passenger car, for example, and is provided with a radiator 13 and a fan unit 16. The radiator 14 is connected to an engine 12 via a pipe 18. Cooling water circulates inside portion of the radiator 14 and the engine 12 through the pipe 18. The radiator 14 is an example of an object to be cooled (i.e. cooled object) according to the present disclosure.

The fan unit 16 is provided with a shroud 20, a fan motor 22 and a fan 24. The fan motor 22 is fixed to the radiator 14 via the shroud 20. The fan 24 is fixed to the fan motor 22. The fan 24 rotates along with an operation of the fan motor 22. The fan 24 sends air to the radiator 14 when rotating.

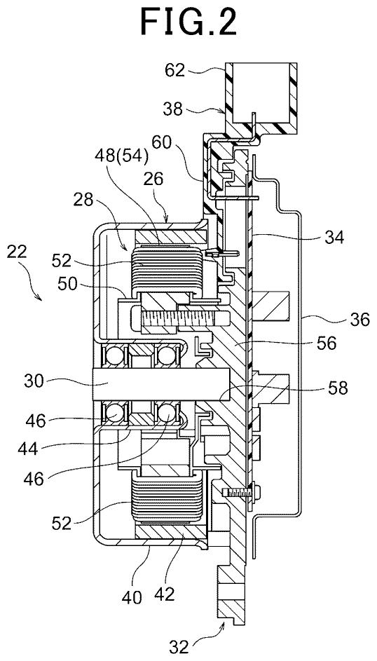

As an example, as shown in FIG. 2, the fan motor 22 is configured as an outer-rotor type brushless motor, including a rotor 26, a stator 28, a shaft 30m a center piece 32, a control circuit 34 and a substrate casing 36 and a connector member 38.

The rotor 26 is provided with a rotor housing 40 and a rotor magnet 42. The rotor housing 40 is formed in a top-sealed cylindrical shape in which a bearing accommodation part 44 (i.e. inner cylindrical part) having a cylindrical shape is provided at a center portion of a top-wall part of the rotor housing 40. For the bearing accommodation part 44, a pair of bearings are accommodated therein. The rotor 26 is rotatably supported by the shaft 30 via the pair of bearings 46. The rotor magnet 42 is fixed to an inner peripheral surface of an outer cylindrical part of the rotor housing 40 using an adhesive material for example.

The stator 27 is accommodated inside the rotor housing 40, including a stator core 48, an insulator 50 and a plurality of windings 52. In the stator core 48, a plurality of teeth 54 is formed extending radially with respect to the shaft 30 as a center thereof. The respective wirings are wound around respective teeth 54 via the insulator 50.

The center piece 32 includes a plate-shaped part 56. The plate-shaped part 56 faces an opening of the rotor housing 40. The stator 28 is fixed to the plate-shaped part 56 via a screw or the like. Thus, the stator 28 is supported by the plate-shaped part 56. A concave part 58 opened towards the stator 28 is formed at a center portion of the plate-shaped part 56. The shaft 30 is fixed to the concave part 58.

The control circuit 34 includes a plurality of switching elements for driving the stator 28. The control circuit 34 is disposed facing the plate-shaped part 56 in a side opposite to the rotor 26. The control circuit 34 is fixed to the plate-shaped part 56 via a screw or the like. The control circuit 34 is one example of a control apparatus according to the present disclosure.

The substrate casing 36 is fixed to the plate-shaped part 56 from an opposite side of the rotor 26. The control circuit 34 is accommodated inside the substrate casing 36. The connector member 38 is fixed to the plate-shaped part 56 by a screw or the like. The connector member 38 includes a connector terminal 60 electrically connected to the control circuit 34 and a connector casing 62 that accommodates the connector terminal 60.

In the fan motor 22, the plurality of switching elements are caused to be switched to change the current flowing through the plurality of windings 52, whereby the stator 28 produces the rotating magnetic field. When the stator 28 produces the rotating magnetic field, a suction force and a repulsion force are produced between the stator 28 and the rotor magnet 42, thereby rotating the rotor 26. For the rotor 26, the fan 24 (see FIG. 1) is fixed thereto and the fan 24 rotates together with the rotor 26.

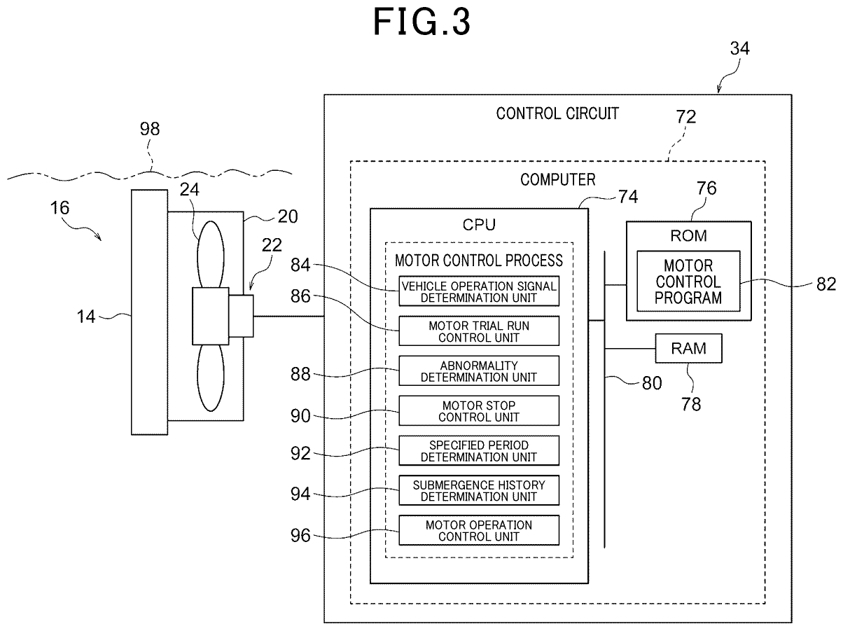

As an example, as shown in FIG. 3, the control circuit 34 is provided with a computer 72. The computer 72 is provided with CPU 74 (central processing unit), ROM 76 (read only memory) and RAM 78 (random access memory). The CPU 74, the ROM 76 and the RAM 78 are communicably connected with each other via a bus 80. In the ROM 76, a motor control program 82 is stored therein. The computer 72 is an example of ‘computer’ according to the present disclosure, the CPU 74 is an example of ‘processor’ according to the present disclosure, the ROM 76 and the RAM 78 are examples of ‘memory’ according to the present disclosure, and the motor control program 82 is an example of ‘program’ according to the present disclosure.

The CPU 74 reads the motor control program 82 from the ROM 76 and executes the motor control program 82 read from ROM 76 on the RAM 78. The CPU 74 executes a motor control process in accordance with the motor control program 82 executed on the RAM 78. The motor control process is accomplished by the CPU 74 operating as a vehicle operation signal determination unit 84, a motor trial-run control unit 86, an abnormality determination unit 88, a motor stop control unit 90, a specified period determination unit 92, a submergence history determination unit 94 and a motor operation control unit 96.

The vehicle operation signal determination unit 84 determines whether a vehicle operation signal (i.e. signal that controls the fan motor 22 to cause the rotor 26 to rotate) outputted from the ECU (electronic control unit, illustration is omitted) mounted on the vehicle is transmitted to the CPU 74. The vehicle operation signal is outputted from the ECU when the temperature of the radiator 14 increases to reach a specified temperature, for example.

Note that the vehicle operation signal may be outputted from the ECU at a predetermined constant time interval. Also, the vehicle operation signal may be outputted from the ECU when a rain sensor (illustration is omitted) detects raindrops. Further, the vehicle operation signal may be outputted from the ECU when a water level detected by a water-level sensor (illustration is omitted) disposed in the vicinity of the fan motor 22 increases to reach a specified water level.

The motor trial-run control unit 86 causes the fan motor 22 to operate as a trial-run when the vehicle operation signal determination unit 84 determines that the vehicle operation signal is transmitted to the CPU 74. The rotation frequency of the fan motor 22 when causing the fan motor 22 to operate as a trial-run may be set to be a rotation frequency when the fan motor 22 operates as a normal operation which will be described later (hereinafter referred to as normal frequency), or may be set to be a rotation frequency lower than the normal rotation frequency.

The abnormality determination unit 88 determines whether an abnormality occurs on the fan motor 22 based on the current value and the rotation frequency of the fan motor 22. Specifically, the abnormality determination unit 88 determines whether a current value of the current supplied to the stator 28 exceeds a predetermined reference current value (i.e. whether there is an overcurrent). The reference current value is set to be an upper limit value of the current in a state where the fan motor 22 operates as a normal operation without entry of foreign substances occurring inside the fan motor 22 and without submergence of the fan motor 22.

In the case where foreign substances enter inside the fan motor 22 to lock the rotor 26 or the fan motor 22 is submerged, whereby resistance of water 98 influences the rotor 26 via the fan 24, a current value of the current supplied to the stator 28 exceeds the reference current value. When the current value of the current supplied to the stator 28 exceeds the reference current value, it may be determined that the rotor 26 is locked or the fan motor 22 is submerged and similar abnormalities occur. FIG. 3 illustrates a state where the fan motor 22 is positioned at a portion lower than a level of the water 98 present in the engine compartment, and being submerged.

Subsequently, when determined that the current value of the current supplied to the stator 28 exceeds the reference current value, the abnormality determination unit 88 determines whether the rotation frequency of the fan motor 22 is a specified rotation frequency or higher. The specified rotation frequency is set to be a rotation frequency higher than a rotation frequency (e.g. rotation frequency 0) at a state where the rotor 26 is locked due to foreign substances which have entered inside the fan motor 22, for example.

In the case where the rotor 22 is not locked because no foreign substances enter inside the fan motor 22, but the fan motor 22 is submerged, whereby resistance of water 98 influences the rotor 26 via the fan 24, the rotation frequency of the fan motor 22 is higher than or equal to the specified rotation frequency. Hence, it is possible to determine, based on the rotation frequency of the fan motor 22, whether the rotor 26 is locked or the fam motor 22 is submerged.

Thus, in the case where the current value of the current supplied to the stator 28 exceeds the reference current value, and the rotation frequency of the fan motor 22 is higher than or equal to the specified rotation frequency, the abnormality determination unit 88 determines that the fan motor 22 is submerged. On the other hand, when the current value of the current supplied to the stator 28 exceeds the reference current value, but the rotation frequency of the fan motor 22 is not higher than the specified rotation frequency, the abnormality determination unit 88 determines that the rotor 26 is locked.

The motor stop control unit 90 stops the fan motor 22 when the abnormality determination unit 88 determines that the fan motor 22 is submerged. Further, the motor stop control unit 90 also stops the fan motor 22 when the abnormality determination unit 88 determines that the rotor 26 is locked.

The specified period determination unit 92 determines whether a time elapsed from a time when the fan motor 22 is caused to be stopped by the motor stop control unit 90 (hereinafter referred to as elapsed time) exceeds a predetermined specified period. The specified period is set to be a required time from when eliminating a submergence of the fan motor 22 in the case fan motor 22 is submerged to when completing draining water from inside portion of the fan motor 22. Even when the submergence of the fan motor 22 is eliminated, but the elapsed time is within the specified period, residual water remains inside the fan motor 22. On the other hand, after eliminating the submergence of the fan motor 22, when the elapsed time exceeds the specified period, draining water from inside portion of the fan motor 22 is completed.

The motor trial-run control unit 86 restarts the fan motor 22 when the specified period determination unit 92 determines that the elapsed time exceeds the specified period. Even when the fan motor 22 is submerged, when the elapsed time exceeds the specified period after eliminating the submergence of the fan motor 22, water is drained from inside the fan motor 22. Hence, when water is drained from inside the fan motor 22 and the rotor 26 is not locked (i.e. no abnormality is present in the fan motor 22), the current value of the current supplied to the stator 28 is lower than or equal to the reference current value. In this case, the abnormality determination unit 88 determines that the current value of the current supplied to the stator 28 does not exceed the reference current value (i.e. submergence is eliminated).

The submergence history determination unit 94 determines, when the abnormality determination unit 88 determines that the current value of the current supplied to the stator 28 does not exceed the reference current value (i.e. no abnormality is present in the fan motor 22), whether there is a history indicating that the most recent determination process performed by the abnormality determination unit 88 determines a submergence of the fan motor 22. The history indicating that the abnormality determination unit 88 determines that the fan motor 22 is submerged, is stored into the RAM 78 for example.

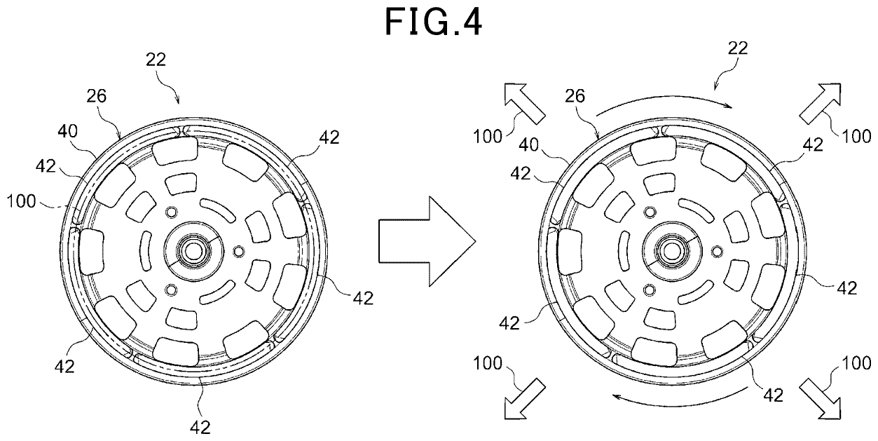

The motor operation control unit 96 causes the fan motor 22 to operate for a predetermined specified period when the submergence history determination unit 94 determines that there is a history indicating that the abnormality determination unit 88 determines a submergence of the fan motor 22. As an example, FIG. 4 shows an example of a state where water drops 100 adhered to the rotor 26 are scattered due to a centrifugal force of the rotor 26. The specified period is set as a period required for scattering water drops 100 with a centrifugal force of the rotor 26. The fan motor 22 operates under a control of the motor operation control unit 96, whereby a water scattering operation is performed to the fan motor 22 for scattering the water drops 100 adhered to the rotor 26 with a centrifugal force of the rotor 26. The rotation frequency of the fan motor 22 when performing the water scattering operation may be set to be an upper limit value of the rated rotation frequency of the fan motor 22 for example. The motor operation control unit 96 stops the fan motor 22 after operating for a specified period.

On the other hand, the motor operation control unit 96 starts to operate the fan motor 22 with a rotation frequency indicated by a vehicle operation signal when the submergence history determination unit 94 determines that there is not a history indicating that the abnormality determination unit 88 determines a submergence of the fan motor 22. Thus, a blower operation is performed to the fan motor 22 in an air-blow mode. The blower operation continues to be performed until a motor stop signal is transmitted to the CPU 74 from the ECU for example.

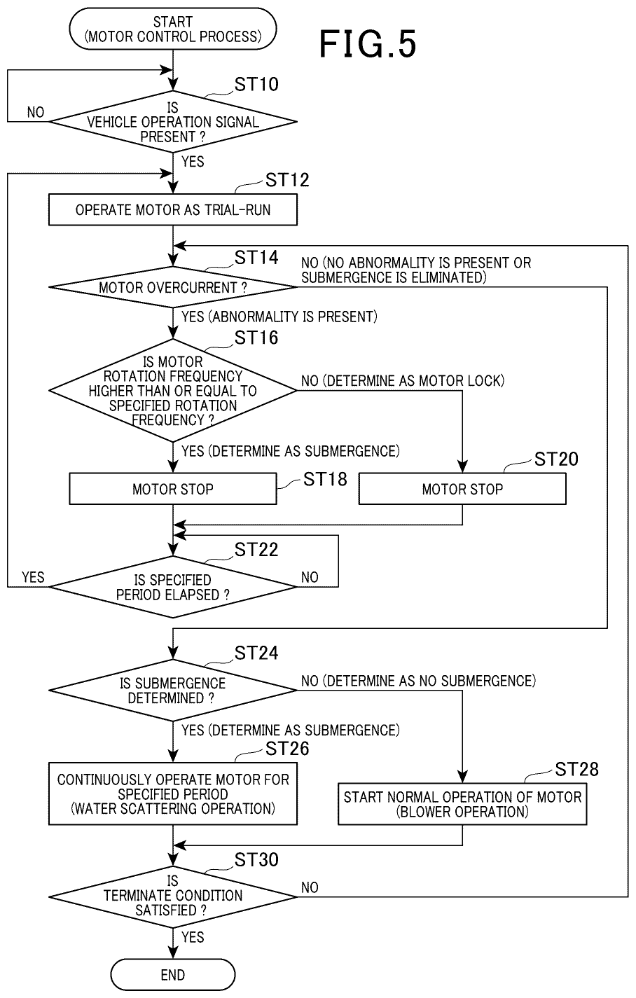

Next, with reference to FIG. 5, a control method according to one embodiment of the present embodiment will be described.

In the motor control process shown in FIG. 5, firstly, at step ST10, the vehicle operation signal determination unit 84 determines whether the vehicle operation signal outputted from the ECU mounted on the vehicle is transmitted to the CPU 74. In the case where the vehicle operation signal is transmitted to the CPU 74 at step ST10, the determination is affirmative and the motor control process proceeds to step ST12. At step ST10, when the vehicle operation signal is not transmitted to the CPU 74, the determination is negative and the motor control process again executes the process of step ST10.

At step ST12, the motor trial-run control unit 86 causes the fan motor 22 to operate as a trial-run. After executing processes of the step ST12, the motor control process proceeds to step ST14.

At step ST14, the abnormality determination unit 88 determines whether the current value of the current supplied to the stator 28 exceeds the reference current value (i.e. whether there is an overcurrent). At step ST14, when the current value of the current supplied to the stator 28 exceeds the reference current value, the determination is affirmative and the motor control process proceeds to step ST16. At step ST14, when the current value of the current supplied to the stator 28 does not exceed the reference current value, the determination is negative and the motor control process proceeds to step ST24.

At step ST16, the abnormality determination unit 88 determines whether the rotation frequency of the fan motor 22 is higher than or equal to the specified rotation frequency. At step ST16, when the rotation frequency of the fan motor 22 is higher than or equal to the specified rotation frequency, the determination is affirmative and the motor control process proceeds to step ST18. At step ST16, when the rotation frequency of the fan motor 22 is not higher than nor equal to the specified rotation frequency, the determination is negative and the motor control process proceeds to step ST20.

At step ST18, the motor stop control unit 90 stops the fan motor 22. After executing the process of step ST 18, the motor control process proceeds to step ST22.

At step ST20, the motor stop control unit 90 stops the fan motor 22. After executing the process of step ST20, the motor control process proceeds to step ST22.

At step ST22, the specified period determination unit 92 determines whether the elapsed time, from a time when the fan motor 22 is stopped by the motor stop control unit 90, exceeds the specified period. At step ST22, when the elapsed time exceeds the specified period, the determination is affirmative and the motor control process proceeds to step ST12. At step ST22, when the elapsed time does not exceed the specified period, the determination is negative and the motor control process again executes the process of step ST22.

At step ST24, the submergence history determination unit 94 determines whether there is a history indicating that the most recent determination process performed by the abnormality determination unit 88 determines a submergence of the fan motor 22. At step ST24, when there is a history indicating that the fan motor 22 is submerged, the determination is affirmative and the motor control process proceeds to step ST26. At step ST24, when there is not a history indicating that the fan motor 22 is submerged, the determination is negative and the motor control process proceeds to step ST28.

At step ST26, the motor operation control unit 96 causes the fan motor 22 to operate for a specified period. Thus, water drops 100 adhered to the rotor 26 are scattered due to a centrifugal force of the rotor 26. The motor operation control unit 96 causes the fan motor 22 to stop after being operated for a specified period. After executing the process at step ST26, the motor control process proceeds to step ST 30.

At step ST28, the motor operation control unit 96 activates the operation of the fan motor 22 at a rotation frequency specified by the vehicle operation signal. Thus, a blower operation is performed to the fan motor 22 in an air-blow mode. After executing the process at step ST 28, the motor control process proceeds to step ST30.

At step ST30, the CPU 74 determines whether a condition for terminating the motor control process (i.e. terminate condition) is satisfied. An example of the termination condition includes a condition where the motor stop signal is transmitted to the CPU 74 from the ECU. In the case where the fan motor 22 is operating and the motor stop signal is transmitted to the CPU 74, the fan motor 22 is stopped. At step ST30, when the termination condition is not satisfied, the determination is negative and the motor control process proceeds to step ST14. At step ST30, when the termination condition is satisfied, the determination is affirmative and the motor control process is terminated.

Next, effects and advantages of one embodiment of the present disclosure will be described.

As described above in detail, the CPU 74 determines whether the fan motor 22 is submerged, and when determined that the fan motor 22 is submerged (step ST16: YES), causes the fan motor 22 to operate (step ST26) after eliminating the submergence of the fan motor 22 (step ST14: NO). Hence, water drops can be prevented from remaining inside the fan motor 22 after eliminating the submergence of the fan motor 22.

Also, the CPU 74 determines whether the fan motor 22 is submerged based on the current value and the rotation frequency of the fan motor 22. Hence, since the fan motor 22 can be determined whether it is submerged without using a water level sensor or the like, the number of components can be reduced compared to a case of using the water sensor or the like.

Further, the CPU 74 continuously operate the fan motor 22, after eliminating submergence of the fan motor 22 (step ST14: NO), until water drops 100 adhered to the rotor 26 of the fan motor 22 are scattered (step ST26). Hence, water drops 100 adhered to the rotor 26 are scattered, whereby water drops 100 can be prevented from remaining inside the fan motor 22.

Next, modification examples of one embodiment according to the present disclosure will be described. In the above-described embodiments, a cooled object of the fan 24 is a radiator 14 for example, but the cooled object may be an object other than the radiator 14. Moreover, for example, the cooled object may be a capacitor of an air-conditioner, a battery of hybrid vehicle (HV) or a battery of electric vehicle (EV).

Further, in the above-described embodiments, the cooling system 10 is applied to a vehicle such as a passenger car as an example, but may be applied to a special vehicle such as an amphibious motor car.

Further, in the above-described embodiments, the control circuit 34 is provided in the fan motor 22, but the fan motor 22 may be provided separately from the fan motor 22. Moreover, the control circuit 34 may be configured of a part of or all of ECU.

Further, in the above-described embodiments, the control circuit 34 is provided with a computer 72 including CPU 74, ROM 76 and RAM 78. However, instead of using the computer 72, ASIC (application specific integrated circuit), FPGA (field programmable gate array) and/or PLD (programmable logic device) may be utilized for the control circuit 34. Also, the instead of using the computer 72, a combination of a software configuration and a hardware configuration may be applied.

The control unit and method thereof disclosed in the present disclosure may be accomplished by a dedicated computer constituted of a processor programmed to execute one or more functions embodied by computer programs. Alternatively, the control unit and method thereof disclosed in the present disclosure may be accomplished by a dedicated computer provided by a processor configured of a dedicated hardware logic circuits. Further, the control unit and method thereof disclosed in the present disclosure may be accomplished by one or more dedicated computer constituted of a combination of a processor programmed to execute computer programs and one or more hardware circuits. Furthermore, the computer programs may be stored, as instruction codes executed by the computer, into a computer readable non-transitory tangible recording media.

Embodiments of the present disclosure are described in the above. The present disclosure is not limited to the above-described embodiments. Apparently, embodiments of the present disclosure may be modified in various manners in addition to the above-described embodiments without departing from the spirit of the present disclosure.

Hereinafter, appendixes will be disclosed for the above-described embodiments.

### (Appendix 1)

A control apparatus (34) that controls a fan motor (22) casing a fan (24) to rotate for blowing air to an object (14) to be cooled, the control apparatus comprising:

a processor (74); and

a memory unit,

wherein

the processor is configured to determine whether the fan motor is submerged and to cause the fan motor to operate after eliminating a submergence of the fan motor in response to determination that the fan motor is submerged.

### (Appendix 2)

The control apparatus according to appendix 1, wherein

the processor is configured to determine whether the fan motor is submerged based on a current value and a rotation frequency of the fan motor.

### (Appendix 3)

The control apparatus according to appendix 1 or 2, wherein

the processor is configured to continuously operate the fan motor, after eliminating the submergence of the fan motor, until water drops adhered to a rotor (26) of the fan motor are scattered.

### (Appendix 4)

A method of controlling a fan motor that causes a fan to rotate for blowing air to an object to be cooled, the method comprising steps of.

determining whether the fan motor is submerged; and

causing the fan motor to operate after eliminating a submergence of the fan motor in response to determination that the fan motor is submerged.

### (Appendix 5)

The method according to appendix 4, wherein

the method determines whether the fan motor is submerged based on a current value and a rotation frequency of the fan motor.

### (Appendix 6)

The method according to appendix 4 or 5,

wherein

the method continuously operates the fan motor, after eliminating the submergence of the fan motor, until water drops adhered to a rotor (26) of the fan motor are scattered.

### (Appendix 7)

A program (82) causing a computer (72) to execute a process of controlling a fan motor that causes a fan to rotate for blowing air to an object to be cooled, the process comprising:

determining whether the fan motor is submerged; and

causing the fan motor to operate after eliminating a submergence of the fan motor in response to determination that the fan motor is submerged.

### (Appendix 8)

The program according to appendix 7,

wherein

the process determines whether the fan motor is submerged based on a current value and a rotation frequency of the fan motor.

### (Appendix 9)

The program according to appendix 7 or 8,

wherein

the process continuously operates the fan motor, after eliminating the submergence of the fan motor, until water drops adhered to a rotor (26) of the fan motor are scattered.

### (Conclusion)

The present disclosure provides a control apparatus, a control method and program thereof capable of preventing water drops from remaining inside a fan motor after eliminating the submergence.

As a first aspect, the present disclosure provides a control apparatus that controls a fan motor casing a fan to rotate for blowing air to an object to be cooled, including a processor and a memory unit. The processor is configured to determine whether the fan motor is submerged and to cause the fan motor to operate after eliminating a submergence of the fan motor in response to determination that the fan motor is submerged.

According to the control apparatus of the first aspect of the present disclosure, water drops can be prevented from remaining inside a fan motor after eliminating the submergence.

A second aspect of the present disclosure is a method of controlling a fan motor that causes a fan to rotate for blowing air to an object to be cooled. The method includes steps of determining whether the fan motor is submerged; and causing the fan motor to operate after eliminating a submergence of the fan motor in response to determination that the fan motor is submerged.

According to the method of the second aspect, water drops can be prevented from remaining inside a fan motor after eliminating the submergence.

A third aspect of the present disclosure is a program causing a computer to execute a process of controlling a fan motor that causes a fan to rotate for blowing air to an object to be cooled. The process includes: determining whether the fan motor is submerged; and causing the fan motor to operate after eliminating a submergence of the fan motor in response to determination that the fan motor is submerged.

According to the program of the third aspect, water drops can be prevented from remaining inside a fan motor after eliminating the submergence.

What is claimed is:

1. A control apparatus that controls a fan motor casing a fan to rotate for blowing air to an object to be cooled, the control apparatus comprising:
a processor, and
a memory unit,
wherein
the processor is configured to determine whether the fan motor is submerged and to cause the fan motor to operate after eliminating a submergence of the fan motor in response to determination that the fan motor is submerged.

2. The control apparatus according to claim 1,
wherein
the processor is configured to determine whether the fan motor is submerged based on a current value and a rotation frequency of the fan motor.

3. The control apparatus according to claim 1,
wherein
the processor is configured to continuously operate the fan motor, after eliminating the submergence of the fan motor, until water drops adhered to a rotor of the fan motor are scattered.

4. A method of controlling a fan motor that causes a fan to rotate for blowing air to an object to be cooled, the method comprising steps of:
determining whether the fan motor is submerged; and
causing the fan motor to operate after eliminating a submergence of the fan motor in response to determination that the fan motor is submerged.

5. A program causing a computer to execute a process of controlling a fan motor that causes a fan to rotate for blowing air to an object to be cooled, the process comprising:
determining whether the fan motor is submerged; and
causing the fan motor to operate after eliminating a submergence of the fan motor in response to determination that the fan motor is submerged.
